(19) United States
(12) Patent Application Publication
(10) Pub. No.: US 2010/0037859 A1
(43) Pub. Date: Feb. 18, 2010

(54) Control device for internal combustion engine, control method, program for performing control method

(75) Inventor: Zenichiro Mashiki, Nissin-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/310,787

(22) PCT Filed: Aug. 20, 2007
(86) PCT No.: PCT/IB2007/002376

§ 371 Date: Mar. 6, 2009

(30) Foreign Application Priority Data
Sep. 7, 2006 (JP) 2006-242904

(51) Int. Cl. F02P 5/00; F02M 7/00; G06F 19/00

(52) U.S. Cl. 123/406.33; 123/436; 701/111

(57) ABSTRACT

An engine ECU runs a program that detects the speed of an engine, a depression amount of an accelerator (ACC) and a vehicle speed, and determines that the vehicle being started from an idle state, if the ACC is more than an ACC threshold value or if the a time differential value (DACC) of the depression amount of the accelerator is more than a DACC threshold value. In addition, the program also detects an intake air temperature (TA), and if the TA is more than a TA threshold value, calculates an air flow guard from a map, which is defined to largely limit the amount of intake air as a KCS learning value is large to a retard side or as the TA is high.

### BACKGROUND OF THE INVENTION

1. Field of the Invention

The present invention relates to a control for an internal combustion engine to restrict occurrence of knock by compensating an ignition timing to a retard side when knock occurs, and more particularly, to a control for an internal combustion engine to adequately restrict knock even when the occurrence of knock cannot be avoided by compensation of an ignition timing in starting (an accelerator depression amount is large and/or a change rate of an accelerator depression amount is large).

2. Description of the Related Art

In an internal combustion engine having a spark plug, an ignition timing control is performed in order to most efficiently obtain an output from combustion and improve exhaust gas purifying performance or a fuel consumption ratio. As already known, it is preferred that a pressure peak in a combustion chamber occurs at a timing slightly later than a top dead point in a compression stroke in order to most efficiently obtain an output from an energy generated by combustion. Accordingly, an ignition timing is determined so that a pressure peak occurs at a timing slightly later than a top dead point in a combustion stroke. However, if the ignition timing is too early (advanced), knock occurs.

An ignition timing of generating the maximum torque in an internal combustion engine is called a MBT (Minimum spark advance for Best Torque). The MBT is different according to a kind of internal combustion engine or the speed of the engine, however it is in the vicinity of the ignition timing in which knock starts occurring. At this time, a knock control is performed so as to obtain the optimum output while restricting knock. On the other hand, when knock does not occur, the ignition timing is gradually advanced. When knock is detected, the ignition timing is gradually retarded until knock does not occur. When knock does not occur, the ignition timing is gradually advanced again. The above compensation of the ignition timing for the knock control is repeated.

The ignition timing is compensated to be retarded based upon a compensation degree which increases or decreases according to whether knock occurs or not, and then an increase in temperature in the combustion chamber is restricted, thereby knock is restricted. The reason of capability of restricting the increase in temperature in the combustion chamber by compensating the ignition timing to the retard side is that a combustion time of a mixed gas in the combustion chamber moves to the retard side by the ignition timing retardation, the mixed gas is exhausted through an exhaust passage as an exhaust gas at a high combustion temperature, and the heat generated during the combustion of the mixed gas is not easily transferred to the combustion chamber. A limit ignition timing in which knock does not occur is called a knock limit ignition timing.

A general ignition timing control is performed by using a basic ignition timing which is predetermined according to the driving state, and a KCS (Knock Control System) compensation value which is a compensation degree from the basic ignition timing to the knock limit ignition timing. That is, the ignition timing is controlled based upon the following relation: ignition timing=basic ignition timing+KCS compensation value. Another compensation value besides the KCS compensation value may be used for the ignition timing control.

In the conventional control device which eliminates knock by delaying the ignition timing, especially when a low-octane fuel is used, because the retardation degree of the ignition timing becomes very large in a state that an opening amount of a throttle valve is large (a state that a pressure in a cylinder is high), there are the problems of an engine output drop, deterioration of a fuel consumption ratio and an increase in an exhaust gas temperature. Japanese Patent Application Publication No. JP-A-63-143360 discloses an intake air amount control device for an engine that is capable of effectively eliminating knock without the problems of deteriorating the fuel consumption ratio, an increasing the exhaust gas temperature, etc. The intake air amount controller for an engine includes a throttle controller, which controls the amount of intake air inducted into the engine by changing an opening amount of a throttle valve in accordance with the depression amount of an accelerator; a maximum-opening amount limiter which changes an upper limit value of the opening amount of the throttle valve with respect to the accelerator operation; a knock sensor which detects a knock state of the engine; and a controller, which controls the maximum-opening amount limitation part to decrease the upper limit value of the opening amount of the throttle valve when it is determined that the engine is in the state that the knock easily occurs, based on the output from the detecting part.

According to the above intake air amount control device for an engine, especially when a low-octane fuel is used to very possibly cause the knock, the control part determines that the engine is in the state that the knock easily occurs, based on the knock state detected from the detecting part. In this case, the control part controls the maximum-opening amount limitation part to decreasingly limit the upper limit value of the opening amount of the throttle valve. Although stepping on an accelerator pedal to a fully depressed position, the throttle valve is not fully opened, and is stopped at the limited opening amount. Accordingly, since the amount of intake air is limited and the pressure in the cylinder is not increased, the knock hardly occurs. The knock can be avoided by decreasing the amount of intake air, however, the engine output drops when compared to the state of the large amount of intake air. Such an output drop is almost equivalent to an output drop due to the ignition timing retardation. The method of avoiding the knock by delaying the ignition timing causes the problems of deterioration of a fuel consumption ratio and an increase in an exhaust gas temperature besides an engine output drop. Because the above conventional intake air amount controller for an engine is configured to eliminate knock by decreasing the amount of intake air, it does not have the problems of deteriorating of the fuel consumption ratio and increasing the exhaust gas temperature.

However, the technique disclosed in Japanese Patent Application Publication No. JP-A-63-143360 just describes that, if the engine is in the state that the knock easily occurs, the control part determines a low-octane fuel being used and the upper limit value of the opening amount of the throttle valve is limited to reduce the opening amount. If the engine is in the state that the knock does not easily occur, the control part determines a high-octane fuel being used and the upper limit value of the opening amount of the throttle valve is not limited so that the opening amount is not reduced. Thus, the above conventional technique cannot adequately avoid the knock which occurs due to various related factors.

Specifically, in starting a vehicle, when improving responsiveness of the opening amount of the throttle valve in order to improve responsiveness of the amount of intake air, the opening amount of the throttle valve may be maximized in the state that the speed of the engine is low. In this case, when a low-octane fuel is used in a high-compression engine of a high output, a “pre ignition” (an early ignition of the mixed gas which is one of the causes of knock) occurs, and the occurrence of knock cannot be avoided by only the ignition timing retardation. Further, when a temperature of the intake air is high, this tendency becomes more conspicuous. The technique disclosed in Japanese Patent Application Publication No. JP-A-63-143360 is to limit the amount of intake air simply based on the octane value of the fuel, resulting in the drop of the engine output over the whole driving region of the engine.

### SUMMARY OF THE INVENTION

The present invention provides a control device for an internal combustion engine, a control method, a program for performing the control method and a recordable medium for storing the program, that can reduces the occurrence of knock when starting a vehicle, despite circumstances in which knock may easily occur (e.g., use of a low-octane fuel).

A control device for an internal combustion engine in accordance with a first aspect of the present invention comprises: a detecting unit for detecting knock occurring in the internal combustion engine of a vehicle; an adjusting unit for adjusting an amount of intake air inducted into the internal combustion engine; a retarding unit for retarding an ignition timing of the internal combustion engine corresponding to detection of knocking; a learning unit for learning the retard amount used in retarding the ignition timing; a calculating unit for calculating a limit value of the amount of intake air with parameters of the learned retard amount and a temperature of intake air inducted into the internal combustion engine; and a control unit for controlling the adjusting unit by using the calculated limit value when the vehicle is started from an idle state of the internal combustion engine. A control method for an internal combustion engine in accordance with the present invention includes the same conditions as the control device for an internal combustion engine in accordance with the first aspect of the present invention.

According to this aspect, in a general case, knock is restricted by retarding the ignition timing so that knock does not occur (advancing the ignition timing each cycle, and when knock occurs, the ignition timing is retarded. In a starting from an idle state, specifically when an depression amount of an accelerator is large or a time differential value of the depression amount of the accelerator is large, as a learned retard amount (KCS learning value) increases, the intake air amount is more strongly limited to further decrease the intake air amount, and the pressure in the cylinder is further decreased, thereby restricting the occurrence of knock. Accordingly, in the starting of a vehicle, the responsiveness of the intake air amount and the responsiveness of the opening amount of a throttle valve are improved. Even when a low-octane fuel is used in the high-compression engine and the opening amount of the throttle valve is maximized in the idle state in which the speed of the engine is low, the occurrence of knock, which cannot be eliminated by only the retarding the ignition timing, can be restricted. As a result, there can be provided a control device and a control method for an internal combustion engine that can adequately restrict knock occurring in the starting of the vehicle under the circumstances that knock easily occurs (e.g., use of a low-octane fuel).

A control device for an internal combustion engine in accordance with a second aspect of the present invention further comprises a unit for detecting the depression amount of an accelerator that is manipulated by a driver of the vehicle. The control unit includes a unit for controlling the adjusting unit by using the calculated limit value of the amount of intake air when the depression amount of the accelerator is larger than a predetermined threshold value. A control method for an internal combustion engine in accordance with the present invention includes the same conditions as the control device for an internal combustion engine in accordance with the second aspect of the present invention.

According to this aspect, if the depression amount of the accelerator is larger than a predetermined threshold value, as the learned retard amount (KCS learning value) increases, the intake air amount is more strongly limited to further decrease the intake air amount, which, in turn, further decreases the pressure in the cylinder, thereby restricting the occurrence of knock, which cannot be avoided by only the ignition timing retardation.

A control device for an internal combustion engine in accordance with a third aspect of the present invention further comprises a unit for detecting a degree of change of an depression amount of an accelerator which is manipulated by a driver of the vehicle. The control unit includes a unit for controlling the adjusting unit by using the calculated limit value of the amount of intake air when the degree of change of the depression amount of the accelerator is larger than a predetermined threshold value. A control method for an internal combustion engine in accordance with the present invention includes the same conditions as the control device for an internal combustion engine in accordance with the third aspect of the present invention.

According to this aspect, if a degree of change of the depression amount of the accelerator (time differential value of the depression amount of the accelerator) is larger than a predetermined threshold value, as the learned retard amount (KCS learning value) increases, the intake air amount is more strongly limited to further decrease the intake air amount, and the pressure in the cylinder is decreased further, thereby reducing the occurrence of knock, which cannot be avoided by only retarding ignition timing.

In a control device for an internal combustion engine in accordance with a fourth aspect of the present invention, the control unit includes a unit for controlling the adjusting unit by using the calculated limit value of the amount of intake air if the temperature of the intake air is higher than a predetermined value when the vehicle is started from the idle state of the internal combustion engine. A control method for an internal combustion engine in accordance with the present invention includes the same conditions as a control device for an internal combustion engine in accordance with the fourth aspect of the present invention.

According to this aspect, because knock easily occurs when the temperature of the intake air is higher than a predetermined threshold value, as the learned retard amount (KCS learning value) increases, the intake air amount is more strongly limited to further decrease the intake air amount, and the pressure in the cylinder is further decreased, thereby restricting the occurrence of knock, which cannot be avoided by only retarding the ignition timing.

In a control device for an internal combustion engine in accordance with a fifth aspect of the present invention, the calculating unit includes a unit for calculating a limit value of the intake air amount to which the intake air amount is restricted. The limit value decreases with increasing the learned retard amount or increasing the temperature of intake air inducted into the internal combustion engine. A control method for an internal combustion engine in accordance with the present invention includes the same conditions as the control device for an internal combustion engine in accordance with the fifth aspect of the present invention.

According to this aspect, when the learned retard amount (KCS learning value) increases, and when the temperature of the intake air inducted into the internal combustion engine is high, the possibility that knock will occur is also high. In this case, the intake air amount is strongly limited to further decrease the intake air amount, and the pressure in the cylinder is further decreased, thereby reducing the occurrence of knock, which cannot be eliminated by only retarding the ignition timing.

A control device for an internal combustion engine in accordance with a sixth aspect of the present invention further comprises a multi-dimensional map related to the engine speed and an engine load. The learning unit derives a compensation value for controlling the ignition timing corresponding to the engine speed and the engine load from the map, and learns by using the compensation value. The learning unit modifies the derived ignition timing control learning value according to conditions influencing a knock limit ignition timing, and initiates the learning by using the modified ignition timing control compensation value. A control method for an internal combustion engine in accordance with the present invention includes the same conditions as the control device for an internal combustion engine in accordance with the sixth aspect of the present invention.

A control method for an internal combustion engine in accordance with a seventh aspect of the present invention further comprises: preparing a map in which a control region for fuel injection into a combustion chamber of the internal combustion engine and a control region for fuel injection into an intake passage of the internal combustion engine are set differently; and controlling selectively the fuel injection into the combustion chamber and the intake passage by using the map, if the temperature of the internal combustion engine is more than a predetermined temperature threshold value. The preparation of the map includes providing a map for a warm engine and a map for a cold engine, and the controlling selectively the fuel injection includes selecting the map for a warm engine if the temperature of the internal combustion engine is more than the predetermined temperature; selecting the map for a cold engine if the temperature of the internal combustion engine is not more than the predetermined temperature; and injecting the fuel into the combustion chamber and/or the intake passage based on the engine speed and the load factor from the map which is respectively selected. The injection of the fuel includes adapting a fuel injection timing to a intake stroke or a compression stroke of the internal combustion engine if the fuel injection into the combustion chamber is selected. The controlling selectively the fuel injection includes using the map for a warm engine independently of the temperature of the internal combustion engine if the internal combustion engine is not in an idle state.

In a program for performing a control method for use in an internal combustion engine by a computer in accordance with an eighth aspect of the present invention, the control method comprises: detecting knock occurring in the internal combustion engine of a vehicle; adjusting an amount of intake air inducted into the internal combustion engine; retarding an ignition timing of the internal combustion engine corresponding to detection of knock; learning a retard amount used in retarding the ignition timing; calculating a limit value of the amount of intake air with parameters of the learned retard amount and a temperature of intake air inducted into the internal combustion engine; and controlling the adjusting the amount of air by using the calculated limit value when the vehicle is started from an idle state of the internal combustion engine. In a recordable medium for storing a program for performing the control method for use in an internal combustion engine by a computer in accordance with a ninth aspect of the present invention, the control method comprises: detecting knock occurring in the internal combustion engine of a vehicle; adjusting an amount of intake air inducted into the internal combustion engine; retarding an ignition timing of the internal combustion engine corresponding to detection of knock; learning a retard amount used in retarding the ignition timing; calculating a limit value of the amount of intake air with parameters of the learned retard amount and a temperature of intake air inducted into the internal combustion engine; and controlling the adjusting the amount of air by using the calculated limit value when the vehicle is started from an idle state of the internal combustion engine.

According to this aspect, the control method for an internal combustion engine in accordance with any one of the above aspects can be achieved by using a computer (general-purpose computer or special-purpose computer).

### BRIEF DESCRIPTION OF THE DRAWINGS

The above and other objects and features of the present invention will become apparent from the following description of example embodiments, given in conjunction with the accompanying drawings, in which:

FIG. 1 is a view illustrating an arrangement of cylinders of an engine, which is controlled by an engine ECU of a control device according to an embodiment of the present invention;

FIG. 2 is a view illustrating a constitution of the engine, which is controlled by the engine ECU of the control device according to an embodiment of the present invention;

FIG. 3 is a functional block diagram of the control device according to an embodiment of the present invention;

FIG. 4 is a view illustrating a map of a guard of an intake air amount inducted into the engine;

FIG. 5 is a flowchart illustrating a control structure of a program that is executed in the engine ECU of the control device according to an embodiment of the present invention;

FIG. 6 is a timing chart of a case which is controlled by the engine ECU of the control device according to an embodiment of the present invention;

FIG. 7 is a view illustrating a map showing a DI ratio when an engine is warm (a first example) which is suitable to be applied with the control device according to an embodiment of the present invention;

FIG. 8 is a view illustrating a map showing a DI ratio when the engine is cold (the first example) which is suitable to be applied with the control device according to an embodiment of the present invention;

FIG. 9 is a view illustrating a map showing a DI ratio when an engine is warm (a second example) which is suitable to be applied with the control device according to an embodiment of the present invention; and

FIG. 10 is a view illustrating a map showing a DI ratio when the engine is cold (the second example) which is suitable to be applied with the control device according to an embodiment of the present invention.

### DETAILED DESCRIPTION OF EMBODIMENTS

Various embodiments of the present invention will now be described in detail with reference to the accompanying drawings. In the following description, the same reference numerals will be given to the same components, which have the same terms and functions. Therefore, the detailed explanation of the same components will be omitted.

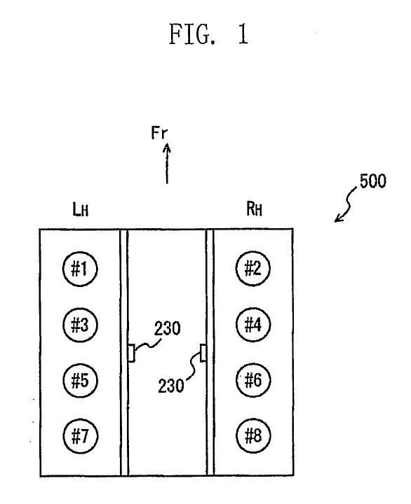

Hereinafter, an engine system including an engine ECU (Electronic Control Unit), which is a control device for an internal combustion engine in accordance with an embodiment of the present invention, will be described. FIG. 1 shows an arrangement of cylinders of an engine 500 controlled by the engine ECU, which is the control device according to this embodiment of the present invention. As shown in FIG. 1, the engine 500 is configured as a 4-cycle reciprocating engine and a V-type 8-cylinder gasoline engine which has eight cylinders. Although this embodiment of the present invention includes the V-type 8-cylinder internal combustion engine, the invention is not restricted thereto.

The first (#1), third (#3), fifth (#5) and seventh (#7) cylinders are arranged in a left bank of a V-bank, and the second (#2), fourth (#4), sixth (#6) and eighth (#8) cylinders are arranged in a right bank of the V-bank. Knock sensors 230 are respectively mounted between the third (#3) cylinder and the fifth (#5) cylinder and between the fourth (#4) cylinder and the sixth (#6) cylinder. However, the number and position of the knock sensors 230 are not restricted to the aforesaid constitution.

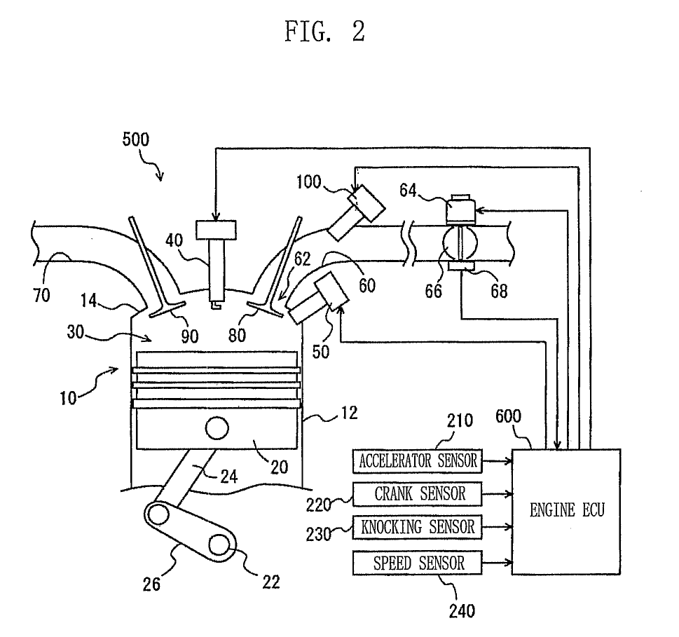

FIG. 2 is a view representatively illustrating one of eight cylinders depicted in FIG. 1. The engine 500 comprises: a cylinder 10 which includes a cylinder block 12 and a cylinder head 14 coupled to an upper portion of the cylinder block 12; and a piston 20 which reciprocatingly moves in the cylinder 10. The piston 20 is connected to a crankshaft 22, which is an output shaft of the engine 500, by a connecting rod 24 and a crank arm 26. The connecting rod 24 converts the reciprocating movement of the piston 20 into the rotation of the crankshaft 22. A combustion chamber 30, in which a mixed gas is combusted, is formed in the cylinder 10 by inner surfaces of the cylinder block 12 and the cylinder head 14 and a top surface of the piston 20.

A spark plug 40 is mounted to the cylinder head 14 while protruding into the combustion chamber 30, to ignite the mixed gas. A cylinder injector 50 for injecting a fuel into the combustion chamber 30 is also mounted to the cylinder head 14. An intake passage 60 and an exhaust passage 70 are connected to the combustion chamber 30, and are respectively communicated with the combustion chamber 30 through an intake valve 80 and an exhaust valve 90. An intake passage injector 100 is mounted to the intake passage 60 to inject the fuel into an intake port 62, which is a junction portion of the intake passage 60 and the combustion chamber 30, and/or into the intake passage 60. Although this embodiment of the present invention includes the internal combustion engine having two separate injectors, the present invention is not restricted to this type of internal combustion engine. For instance, the present invention may also be applied to an internal combustion engine which is provided with a single injector having both functions of injecting the fuel into the combustion chamber and into the intake passage.

The engine 500 further includes an accelerator sensor 210, a crank sensor 220, a knock sensor 230, and a speed sensor 240. As shown in FIG. 1, two knock sensors 230 are provided at two positions in the engine 500.

The accelerator sensor 210 is provided near an accelerator pedal (not shown) to detect the depression amount of the accelerator. The detected value is A/D converted appropriately by the engine ECU 600, and is transmitted to a microcomputer provided in the engine ECU 600.

The crank sensor 220 includes a rotor mounted to the crankshaft 22 of the engine 500, and an electronic pickup mounted near the rotor to detect the passing of a protrusion provided on an outer periphery of the rotor. The crank sensor 220 is a sensor for detecting a rotational phase of the crankshaft 22 (crank angle) and a rotational speed of the engine 500. The output of the crank sensor 220 is appropriately transformed into a wave form by the engine ECU 600, and is transmitted to the microcomputer in the engine ECU 600 as a pulse signal according to the rotational speed of the crankshaft 22 (NE pulse).

The speed sensor 240 detects the rotational speed of an output shaft of an automatic transmission (NOUT). The engine ECU 600 can calculate a vehicle speed by multiplying rotational speed of the output shaft (NOUT) by a final gear ratio. The speed sensor 240 may be configured as a sensor that can directly detect the vehicle speed.

Also, an air cleaner (not shown), an air flow meter (not shown), and a throttle valve 66 are mounted to the intake passage 60, in sequence from the upstream side thereof. A throttle motor 64 and a throttle position sensor 68 are mounted to the throttle valve 66.

The air passing through from the air cleaner flows through the intake passage 60 and into the engine 500. The throttle valve 66 is mounted on the way of the intake passage 60. The throttle valve 66 is opened and closed by the operation of the throttle motor 64. The opening amount of the throttle valve 66 can be detected by the throttle position sensor 68. The air flow meter is mounted to the intake passage 60, at a position between the air cleaner and the throttle valve 66, and detects the amount of intake air. The air flow meter transmits an air-intake signal that indicates the amount of intake air (Q) inducted to the engine ECU 600. The air flow meter is provided with a temperature sensor, and the temperature sensor transmits an air temperature signal representing a temperature of the intake air (TA) to the engine ECU 600.

The knock sensor 230 is mounted to the cylinder block 12 of the engine 500. The knock sensor 230 is a sensor for detecting the vibration including knock occurring in the engine 500. The output of the knock sensor 230 is transmitted to the engine ECU 600, as a knock signal that indicates the magnitude of the vibration.

The engine ECU 600 includes a CPU (Central Processing Unit) which functions as a microcomputer, an A/D converter, a waveform shaping circuit, memory in which various data or calculating results are temporarily stored, and a drive (driving circuit) for driving various actuators. According to the driving state of the engine, which is analyzed by the detected signals, etc., from the respective sensors, the engine ECU 600 controls the ignition timing of the spark plug 40 or the fuel injection of the cylinder injector 50 and the intake passage injector 100.

The engine ECU 600 operates as a knock control system (KCS) that reduces the occurrence of knock in the engine 500. The knocking restriction by the knock control system will now be described in detail.

The engine ECU 600 sets a period when it is possible for knock to occur in the engine 500, i.e., a period from when the piston approximates to the top dead point (compression stroke) in each cylinder to when the ignition is terminated, to a knock determination period (gate), and distinguishes the vibration inherent to knock from the signal detected from the knock sensor 230 that corresponds to the vibration of the cylinder block 12 during the knock determination period. Specifically, the engine ECU 600 counts the number of times that the output peak value from the knock sensor 230 exceeds a determination reference value during the knock determination period, and if the number of times is more than a predetermined number, the engine ECU 600 determines that the vibration inherent to knock occurs. And, based on such a determination, the engine ECU 600 detects knock.

If knocking is detected, the engine ECU 600 executes a retard compensation control of the ignition timing (by adding the KCS compensation value to the basic ignition timing) to restrict knock. Particularly, the retard amount of the ignition timing increases whenever knock is detected. When knock is not detected, the retard amount of the ignition timing decreases to advance the ignition timing. By such an ignition timing control, the ignition timing is adjusted to knock limit, so that the output of the engine 500 can increase as high as possible while restricting knock. Also, to prevent the excessive retardation of the ignition timing due to the frequent occurrence of knock, the retard amount of the ignition timing is guarded to a preset upper limit guard value (G).

KCS learning used to restrict knock by the knock control system will now be described in detail.

The ignition timing is determined by the basic ignition timing and the KCS compensation value (ignition timing=basic ignition timing+KCS compensation value (+another compensation value as needed)). The basic ignition timing is determined by considering a change of a climate condition, etc., and is designed to have a margin of a certain extent with respect to the ignition timing when knock occurs. Accordingly, the ignition timing is advanced to the MBT (Minimum spark advance for Best Torque) near the occurrence of knock by using the KCS compensation value to obtain the optimum output.

The knock limit ignition timing (=basic ignition timing+KCS compensation value) is respectively different according to a kind of engine 500, the driving state or aging of the engine 500, a climate condition, etc. Therefore, the knock control system always learns the KCS compensation value. The knock control system derives the KCS compensation value corresponding to the driving state of the engine 500 from a KCS compensation value map, and learns the derived KCS compensation value. For instance, a two-dimensional map (or three or more multi-dimensional map) related to the engine speed and the engine load with respect to the KCS compensation value is provided, and the knock control system derives the KCS compensation value corresponding to the driving state of the engine (the engine speed and the engine load) from the map and learns the derived KCS compensation value.

The derived KCS compensation value is renewed under the driving state or the climate condition in the last learning time. In spite of the driving state or the climate condition being changed at the current time, because it may take much time in performing the second learning operation due to the above reason, it does not matter that the derived KCS learning value is first modified according to various conditions which have influences on the knock limit ignition timing and then the learning operation is initiated using the modified KCS compensation value. By performing the one-time modification as above, the learning operation of the KCS compensation value can be terminated as soon as possible.

Besides the operational effect of avoiding knock by the ignition timing compensation as described above, the engine ECU 600 can control the conversion between the fuel injection by the cylinder injector 50 and the fuel injection by the intake passage injector 100. Such a conversion control is performed based on the driving state of the engine, i.e., the engine speed and the engine load, so that the fuel injection type appropriate for the driving state of the engine at that time is selected. When the fuel injection by the cylinder injector 50 is selected, the fuel injection by the intake passage injector 100 is selected, or the fuel injection by both the injectors 50 and 100 is selected, the fuel injection timing or the fuel injection amount is controlled adequately for the driving state of the engine. The detailed explanation of the fuel injection control will be made later.

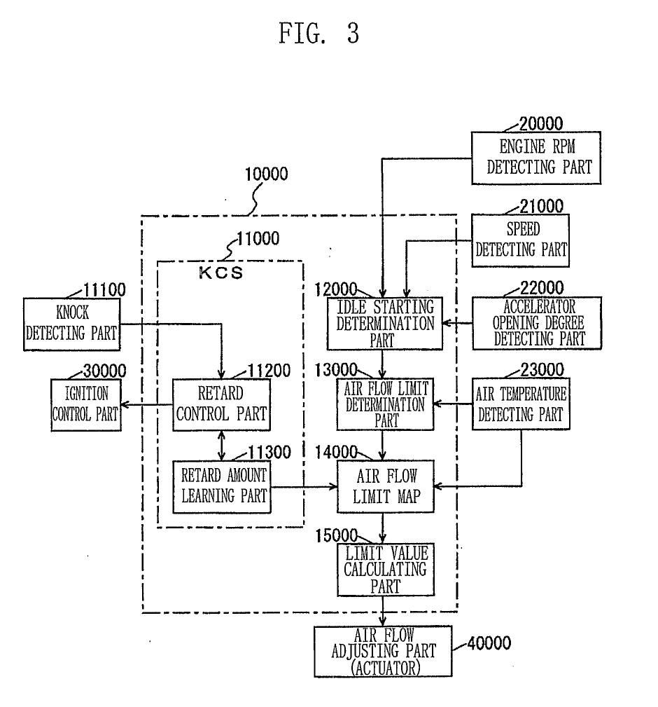

FIG. 3 is a functional block diagram of the control device in accordance with this embodiment of the present invention. As shown in FIG. 3, the control device includes a control unit 10000, an ignition control part 30000, an airflow adjusting part (actuator) 40000, and detecting parts (various sensors). The sensors included may be, for example, an engine speed sensor 20000, which detects the engine speed (NE); a vehicle speed sensor 21000, which detects the vehicle speed; an accelerator depression amount sensor 22000, which detects the depression amount of the accelerator; and an air temperature sensor 23000, which detects the temperature of the intake air inducted into the engine.

The control unit 10000 includes a KCS 11000, which controls the ignition timing to restrict knock; an idle starting determination part 12000 that determines whether the starting is performed from the idle state based on the engine speed (NE), the vehicle speed and the depression amount of the accelerator; and an air flow limit determination part 13000, which determines whether to limit the amount of the intake air inducted into the engine 500 based on the air temperature when it is determined that the starting is performed from the idle state.

The KCS 11000 includes a retard control part 11200 which retards the ignition timing if a knock detecting part 11100 detects knocking, and a retard amount learning part 11300 which learns the retard compensation amount used in the retard control part 11200.

The control unit 10000 includes a two-dimensional air flow limit map 14000, which is used when it is determined to limit the air amount and has parameters of the learned retard compensation amount, i.e., the KCS learning value and the temperature of the intake air inducted into the engine 500; and a limit value calculating part 15000, which calculates the limit value of the amount of intake air inducted into the engine 500 by using the air flow limit map 14000. By using the limit value calculated from the limit value calculating part 15000, the air flow adjusting part (actuator) 40000 (e.g., throttle motor 64) controls the opening degree of the throttle valve, and adjusts the amount of intake air inducted into the engine 500.

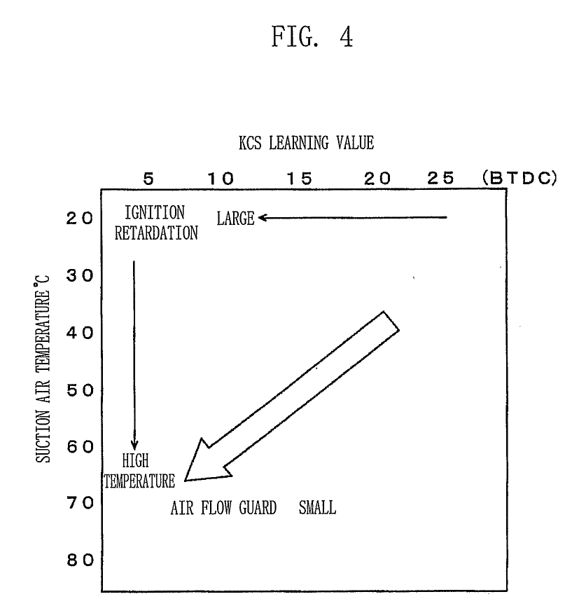

The air flow limit map 14000, which is stored in the memory of the engine ECU 600 (control device in accordance with this embodiment of the present invention) and limits the amount of intake air (Q) inducted into the engine 500, will now be described with reference to FIG. 4.

As shown in FIG. 4, the map is a two-dimensional map in which the horizontal axis represents the KCS learning value and a vertical axis represents the intake air temperature. When the KCS learning value is small (because the ignition timing is slightly retarded, knock easily occurs, and specifically when a low-octane fuel is used, the occurrence of knock becomes conspicuous) or the intake air temperature is high (knock easily occurs, and specifically when a low-octane fuel is used, the occurrence of knock becomes conspicuous), the airflow guard value is set to have a tendency of decreasing (being lowered). That is, when the KCS learning value is small or the intake air temperature is high, the amount of intake air inducted into the engine 500 is considerably limited.

In situations where knock occurs more easily, the air amount is further decreased, and the pressure in the cylinder is decreased, thereby restricting the occurrence of. knock. The present invention is not restricted to the map depicted in FIG. 4. For instance, the horizontal axis may be set to represent the KCS compensation value or the ignition timing instead of the KCS learning value.

The control unit 10000 in the functional block shown in FIG. 3 may be implemented by a hardware that is composed of a digital circuit or an analog circuit, or may be implemented by software which is composed of a program which is read from the memory and run by the CPU of the engine ECU 600. When the control unit is implemented by hardware, it is advantageous in the operational speed. When the control unit is implemented by the software, it is advantageous in the design change. Hereinafter, the control device realized by the software will be described. A recordable medium for storing such a program will also be described.

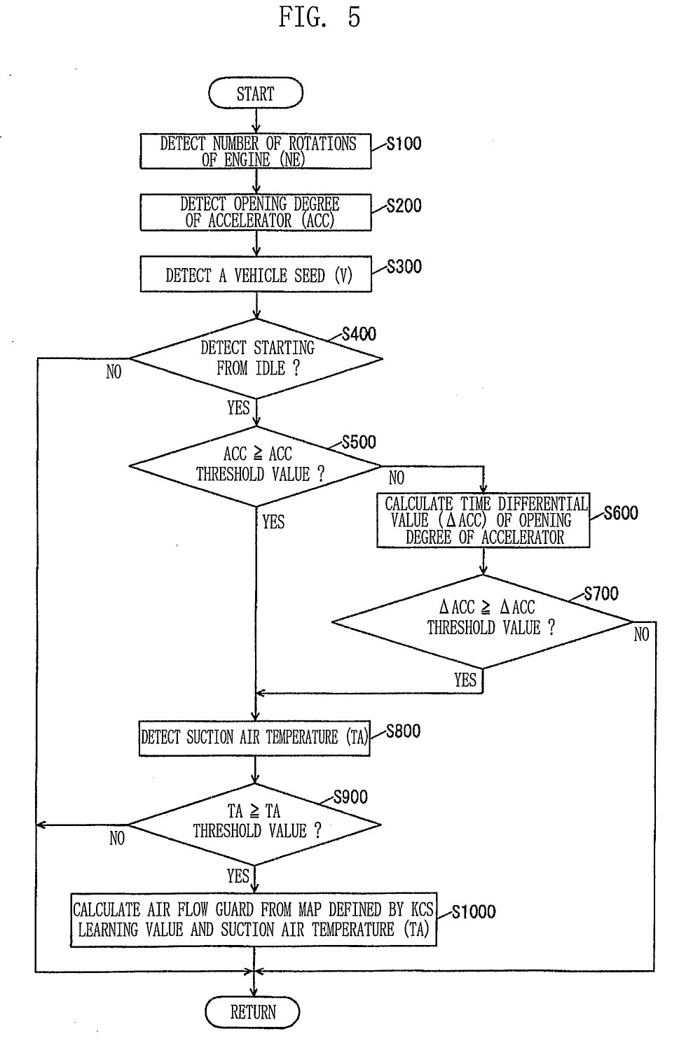

A control structure of a program executed in the engine ECU 600 will now be described with reference to FIG. 5. The program is executed at a predetermined intervals.

The engine ECU 600 detects the engine speed (NE) based on the signal from the crank sensor 220 at step S100. The engine ECU 600 detects the depression amount of the accelerator (ACC) based on the signal from the accelerator depression amount sensor 210 at step S200. The engine ECU 600 detects the vehicle speed (V) based on the signal from the speed sensor 240 at step S300.

The engine ECU 600 determines whether the starting is performed from idle at step S400. At this time, if the engine speed (NE) is a value near engine idle speed, the vehicle speed (V) is 0, and the depression amount of the accelerator (ACC) is changed (opened) from 0, the engine ECU detects that the starting is performed from the idle. If the engine ECU 600 detects that the starting is performed from idle (YES at step S400), the process goes to step S500. If not (NO at step S400), the process is terminated.

The engine ECU 600 determines whether the detected depression amount of the accelerator (ACC) is more than an ACC threshold value at step S500. If the detected depression amount of the accelerator (ACC) is more than the ACC threshold value (YES at step S500), the process goes to step S800. If not (NO at step S500), the process goes to step S600.

The engine ECU 600 calculates a time differential value (ΔACC) of the detected depression amount of the accelerator (ACC) at step S600. The engine ECU 600 determines whether the calculated time differential value (ΔACC) of the depression amount of the accelerator is more than a ΔACC threshold value at step S700. If the calculated time differential value (ΔACC) of the depression amount of the accelerator is more than the ΔACC threshold value (YES at step S700), the process goes to step S800. If not (NO at step S700), the process is terminated.

The engine ECU 600 detects the temperature of the intake air (TA) inducted into the engine 500 at step S800. At this time, the engine ECU 600 detects the intake air temperature (TA) based on the signal from the temperature sensor mounted in the air flow meter, which detects the intake air amount.

The engine ECU 600 determines whether the detected intake air temperature (TA) is more than a TA threshold value at step S900. If the detected intake air temperature (TA) is more than the TA threshold value (YES at step S900), the process goes to step S1000. If not (NO at step S900), the process is terminated.

The engine ECU 600 calculates the air flow guard from the map shown in FIG. 4, which has the parameters of the KCS learning value and the intake air temperature (TA), at step S1000.

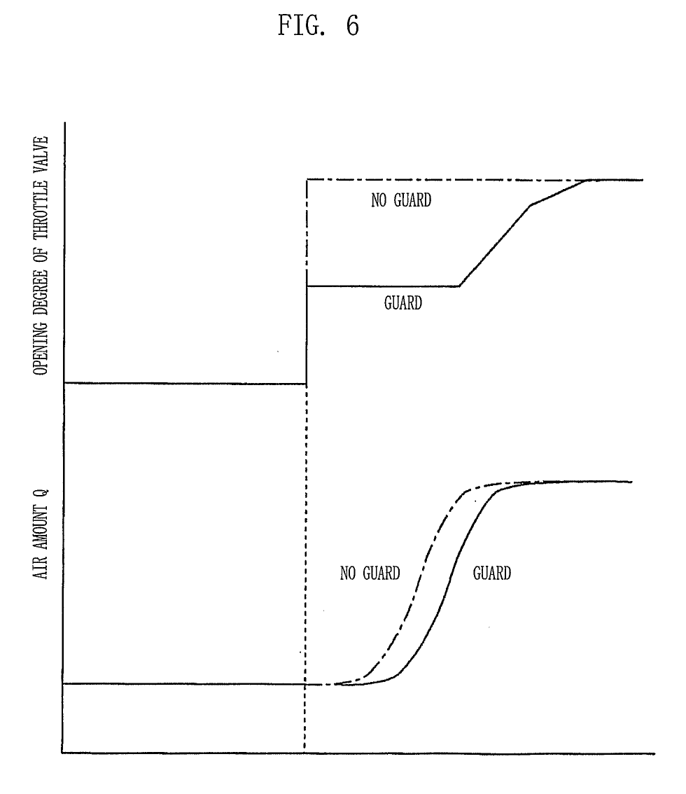

In the engine system loaded with the engine ECU 600 in accordance with this embodiment of the present invention, when the vehicle is started from the idle state, the operation of changing the intake air amount to avoid knock based on the aforesaid structure and the flowchart will now be described with reference to FIG. 6.

When the engine speed (NE), the depression amount of the accelerator (ACC) and the vehicle speed (V) are detected at steps S100, S200 and S300, and it is detected that the vehicle is started (the depression amount of the accelerator (ACC) increases from 0, and the vehicle speed increases from 0) from the idle state in which the engine speed is low (YES at step S400), the process is performed as follows.

The intake air temperature (TA) is detected at step S800 under following conditions: if the accelerator pedal is depressed deeply such that the depression amount of the accelerator (ACC) is more than the ACC threshold value (YES at step S500), or if the depression amount of the accelerator (ACC) is not more than the ACC threshold value (NO at step S500); and the accelerator pedal is depressed fast such that the time differential value (ΔACC) of the depression amount of the accelerator is more than the ΔACC threshold value (YES at step S700).

If the intake air temperature (TA) is more than the TA threshold value (YES at step S900), knock easily occurs due to the high intake air temperature (TA). Therefore, the airflow guard is calculated from the map shown in FIG. 4, which is defined by the KCS learning value and the intake air temperature (TA), at step S1000.

FIG. 6 shows the changes of the throttle depression amount and the air amount (Q) with the passage of time when the airflow guard is calculated and the opening amount of the throttle valve 66 is limited, by a solid line. FIG. 6 also shows the changes of the throttle opening amount and the air amount (Q) with the passage of time when the airflow guard is not calculated and the opening amount of throttle valve 66 is not limited, by a dashed dotted-line. Compared to the case of no guard, when the guard is calculated, the pressure in the cylinder is decreased to limit the air amount (Q) to a small enough extent that the occurrence of knock can be avoided in the situation that knock easily occurs.

When a low-octane fuel is used in the high-compression engine and the opening amount of the throttle valve is maximized in the starting from the idle state in which the engine speed is low, knock easily occurs due to the high intake air temperature. At this time, knock cannot be eliminated by only the retarding ignition timing. In order to avoid the occurrence of knock in this situation, the intake air amount (Q) is limited based on the map shown in FIG. 4.

As described above, according to the control method by the engine ECU in accordance with this embodiment of the present invention, when the depression amount of the accelerator is large or the time differential value of the depression amount of the accelerator is large in the starting from the idle state, as increases, the intake air amount is more strongly limited to further decrease the intake air amount, and the pressure in the cylinder is further decreased, thereby eliminating the occurrence of knock. Also, as the intake air temperature is high, the intake air amount is more limited to further decrease the intake air amount, and the pressure in the cylinder is further decreased, thereby avoiding the occurrence of knock. Accordingly, in the starting of the vehicle, the responsiveness of the intake air amount and the responsiveness of the opening amount of the throttle valve are improved. As a result, even when a low-octane fuel is used in the high-compression engine and the opening degree of the throttle valve is maximized in the starting from the idle state in which the engine speed is low, the occurrence of knock, which cannot be eliminated by only the retarding ignition timing, can be avoided.

The limitation of the intake air amount may be achieved by directly limiting the opening amount of the throttle valve, or by estimating the air amount for the engine load and limiting the estimated air amount.

Hereinafter, an engine suitable to be applied with the control device in accordance with this embodiment of the present invention will be described.

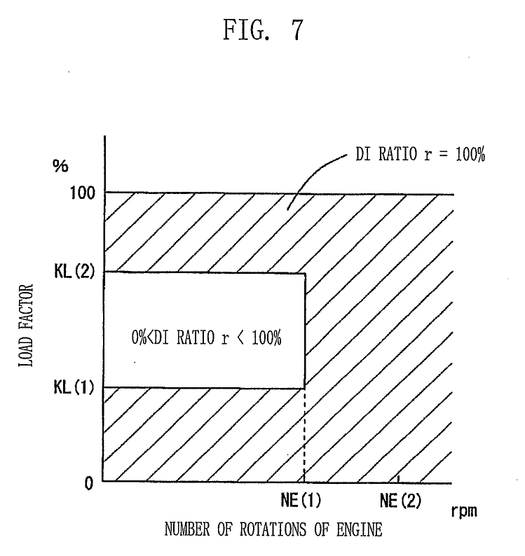

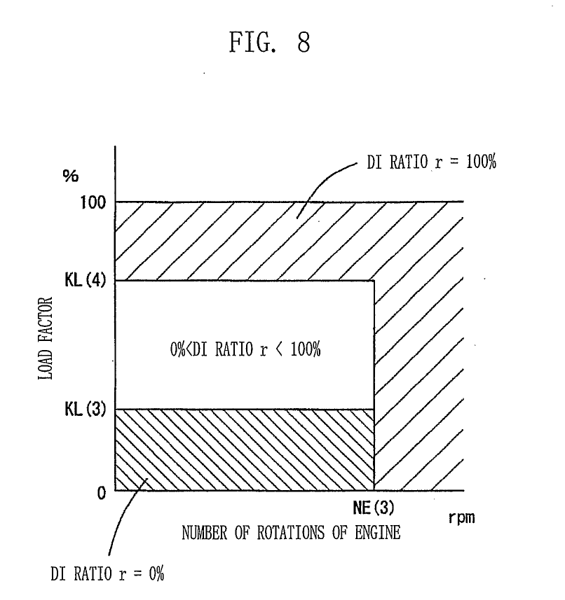

Referring to FIGS. 7 and 8, maps, which store information corresponding to the driving state of the engine 500 and show an injection distribution ratio of the cylinder injector 50 and the intake passage injector 100 (hereinafter, referred to as “DI ratio r”), will be described. The maps are stored in the memory of the engine ECU 600. FIG. 7 shows the map for a warm the engine 500, and FIG. 8 shows the map for a cold engine 500.

As shown in FIGS. 7 and 8, each of the maps is configured such that a horizontal axis represents the rotational speed of the engine 500, a vertical axis represents a load factor, and the injection distribution ratio of the cylinder injector 50 (DI ratio r) is shown by a percentage.

As shown in FIGS. 7 and 8, the DI ratio r is set in the respective driving regions which are defined by the rotational speed of the engine 500 and the load factor. “DI ratio r=100%” refers to a region in which the fuel injection is performed by only the cylinder injector 50, and “DI ratio r=0%” refers to a region in which the fuel injection is performed by only the intake passage injector 100. “DI ratio r≠0%”, “DI ratio r≠100%”, and “0% <DI ratio r<100%”, respectively refer to a region in which the fuel injection is performed while being shared by the cylinder injector 50 and the intake passage injector 100. Generally, the cylinder injector 50 contributes to the increase in the output, and the intake passage injector 100 contributes to the uniformity of the mixed gas. These two kinds of injectors having different features may be used together or separately according to the rotational speed of the engine 500 and the load factor, so that only the homogeneous combustion is performed when the engine 500 is in an ordinary driving state (for example, a catalyst warm-up state in the idle state is one example of an unusual driving state).

As shown in FIGS. 7 and 8, the maps are classified into the map for a warm engine and the map for a cold engine, and define the DI ratio r of the cylinder injector 50 and the intake passage injector 100. If the temperature of the engine 500 is changed, the temperature of the engine 500 is detected by using the maps in which the control region of the cylinder injector 50 and the control region of the intake passage injector 100 are set differently. If the temperature of the engine 500 is more than a predetermined temperature, the map for a warm engine, depicted in FIG. 7, is selected. If not, the map for a cold engine, depicted in FIG. 8, is selected. Based on the rotational speed of the engine 500 and the load factor set in the respectively selected map, the cylinder injector 50 and/or the intake passage injector 100 are controlled.

The rotational speed of the engine 500 and the load factor set in the maps depicted in FIGS. 7 and 8 will now be described. In FIG. 7, NE (1) is set to a range of 2500 to 2700 rpm, KL (1) is set to a range of 30 to 50%, and KL (2) is set to a range of 60 to 90%. In FIG. 8, NE (3) is set to a range of 2900 to 3100 rpm. That is, the NE (1) is lower than the NE (3) (NE (1)<NE (3)). Besides, NE (2) in FIG. 7, and KL (3) and KL (4) in FIG. 8 are adequately set.

When comparing FIG. 7 and FIG. 8, NE (3) in the map for a cold engine, depicted in FIG. 8, is higher than NE (1) in the map for a warm engine, depicted in FIG. 7. This indicates that when the temperature of the engine 500 is low, the control region of the intake passage injector 100 is extended to the region in which the rotational speed of the engine is high. In other words, because the engine 500 is becoming cold, a deposit is not easily accumulated on a nozzle of the cylinder injector 50 (for example, in spite of not injecting the fuel from the cylinder injector 50). Accordingly, it can be set that the fuel injection region is extended using the intake passage injector 100 so as to increase the homogeneity.

When comparing FIG. 7 and FIG. 8, the DI ratio r is 100% in the region in which the rotational speed of the engine 500 is more than NE (1) in the map for a warm engine and in the region in which the rotational speed of the engine 500 is more than NE (3) in the map for a cold engine. Also, the DI ratio r is 100% in the region in which the load factor is more than KL (2) in the map for a warm state and in the region in which the load factor is more than KL (4) in the map for a cold state. This indicates that only the cylinder injector 50 is used in the predetermined region of the high speed of the engine or in the predetermined region of the high engine load. In the high rotational speed region or the high load region, because the intake air amount is increased due to the high speed of the engine 500 or the high engine load, the homogeneity of the mixed gas can be easily achieved by the fuel injection from only the cylinder injector 50. The fuel injected from the cylinder injector 50 is vaporized with latent heat of vaporization in the combustion chamber (by absorbing the heat from the combustion chamber). Accordingly, the temperature of the mixed gas in the compression end of the engine drops. As a result, the engine performance against knock increases. Further, because the temperature of the combustion chamber drops, the intake efficiency is improved and the high output can be obtained.

In the map for a warm engine depicted in FIG. 7, only the cylinder injector 50 can be adopted in the region in which the load factor is less than KL (1). This indicates that only the cylinder injector 50 is used in the predetermined region of the low engine load and the high temperature of the engine 500. Because the engine 500 is becoming warm, a deposit is easily accumulated on the nozzle of the cylinder injector 50. However, because the temperature of the nozzle can be decreased by injecting the fuel from the cylinder injector 50, the accumulation of the deposit can be avoided, and the minimum fuel injection amount of the cylinder injector 50 is secured, thereby preventing choking of the nozzle of the cylinder injector 50. Accordingly, the region in which the load factor is less than KL (1) is set to adopt the cylinder injector 50.

When comparing FIG. 7 and FIG. 8, the region of “DI ratio r=0%” exists only in the map for a cold state depicted in FIG. 8. This indicates that only the intake passage injector 100 is used in the predetermined region of the low engine load (less than KL (3)) and the low temperature of the engine 500. Because the intake air amount is small when the engine 500 is cooled and the load of the engine 500 is low, the fuel is difficult to be atomized. Because the combustion cannot be smoothly achieved by the fuel injection from the cylinder injector 50 in the above region, and also because the high output obtained by adopting the cylinder injector 50 is not needed in the region of the low engine load and the low number of rotations, only the intake passage injector 100 is used without using the cylinder injector 50.

In the state except for the ordinary driving state, e.g., the catalyst warm-up state during the idle of the engine 500 (unusual driving state), the cylinder injector 50 is controlled to perform the stratified combustion. By performing the stratified combustion only during the catalyst warm-up state, a catalyst warm-up acceleration mode is carried out, and exhaust emission is improved.

Hereinafter, a second engine suitable to be applied with the control device in accordance with this embodiment of the present invention will be described. The same explanation of the engine (the second example) as the engine (the first example) will be omitted.

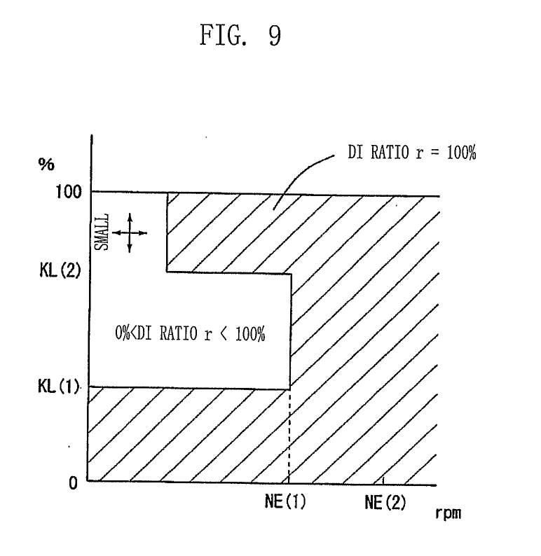

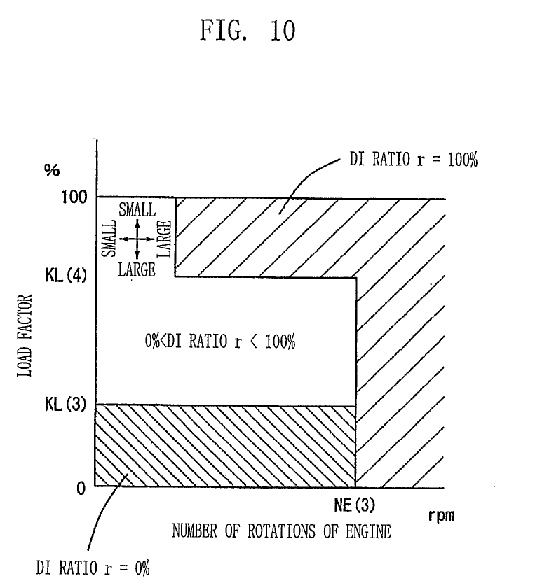

Referring to FIGS. 9 and 10, maps that store information corresponding to the driving state of the engine 500 and show an injection distribution ratio of the cylinder injector 50 and the intake passage injector 100 will be described. The maps are stored in the memory of the engine ECU 600. FIG. 9 shows the map for a warm engine 500, and FIG. 10 shows the map for a cold engine 500.

The maps shown in FIGS. 9 and 10 differ from the maps shown in FIGS. 7 and 8 in the following points. The DI ratio r is 100% in the region in which the speed of the engine 500 is more than NE (1) in the map for a warm engine and in the region in which the speed of the engine 500 is more than NE (3) in the map for a cold engine. Also, the DI ratio r is 100% in the region in which the load factor is more than KL (2) except for the region of the low speed in the map for a warm engine and in the region in which the load factor is more than KL (4) except for the region of the low speed in the map for a cold engine. This indicates that only the cylinder injector 50 is used in the predetermined region of the high speed of the engine or in a broad range of the predetermined region of the high engine load. However, in the high load and low speed region, because mixing of the mixed gas formed by the fuel injected from the cylinder injector 50 is not sufficiently achieved, the mixed gas in the combustion chamber is not homogeneous, which results in unstable combustion. Therefore, as it goes to the region of the high speed in which the above problems do not occur, the injection ratio of the cylinder injector 50 is increased. As it goes to the region of the high load in which the above problems occur, the injection ratio of the cylinder injector 50 is decreased. The change of the DI ratio r is illustrated by cross arrows in FIGS. 9 and 10. By the above control, the change of the output torque of the engine due to the unstable combustion can be restricted. The above control is substantially equivalent to a control such that, as it goes to the predetermined region of the low speed, the injection ratio of the cylinder injector 50 is decreased, or as it goes to the predetermined region of the low load, the injection ratio of the cylinder injector 50 is increased. Also, in the region except for the above region (illustrated by the cross arrows in FIGS. 9 and 10), and the region in which the fuel is injected from only the cylinder injector 50 (the region of the high speed, the region of the low load), the mixed gas becomes easily homogeneous by only the cylinder injector 50. The fuel injected from the cylinder injector 50 is vaporized with latent heat of vaporization in the combustion chamber (by absorbing the heat from the combustion chamber). Accordingly, the temperature of the mixed gas in the compression end of the engine drops. As a result, the engine performance against knock increases. Further, since the temperature of the combustion chamber drops, the intake efficiency is improved and the high output can be obtained.

In the engine 500 described with reference to FIGS. 7 to 10, the homogeneous combustion is achieved by adapting the fuel injection timing of the cylinder injector 50 to the intake stroke, and the stratified combustion is achieved by adapting the fuel injection timing of the cylinder injector 50 to the compression stroke. That is, by adapting the fuel injection timing of the cylinder injector 50 to the compression stroke, the rich mixed gas is locally concentrated around the spark plug, and thus the stratified combustion by igniting the lean mixed gas can be achieved in the overall combustion chamber. Also, even when adapting the fuel injection timing of the cylinder injector 50 to the intake stroke, so long as the rich mixed gas can be locally concentrated around the spark plug, the stratified combustion may be achieved in spite of the intake stroke injection mode.

The above-mentioned stratified combustion includes both the stratified combustion and the lean stratified combustion, which are described below. The lean stratified combustion is achieved in such a manner that the fuel is injected from the intake passage injector 100 during the intake stroke to generate the lean homogeneous mixed gas in the overall combustion chamber and the fuel is injected from the cylinder injector 50 during the compression stroke to generate the rich mixed gas around the spark plug, thereby improving the combustion performance. It is preferable to perform the lean stratified combustion in the catalyst warm-up state. The reason is as follows. In the catalyst warm-up state, in order for the combustion gas of high temperature to be delivered to the catalyst, it is necessary to significantly retard the ignition timing and maintain a favorable combustion state (idle state). Also, it is necessary to supply the fuel amount of a certain degree. When intending to perform the stratified combustion, there is the problem that the fuel amount is insufficient. When intending to perform the homogeneous combustion, there is the problem that the retard amount is insufficient to maintain the favorable combustion when compared to the stratified combustion. From this point of view, it is preferable to perform the lean stratified combustion in the catalyst warm-up state, however it does not matter if either the stratified combustion or the lean stratified combustion is performed.

In the engine described with reference to FIGS. 7 to 10, it is preferable to adapt the fuel injection timing of the cylinder injector 50 to the compression stroke by the following reasons. In the most basic region in the engine 500 (the basic region is defined as a region except for the region of the lean stratified combustion which is performed in only the catalyst warm-up state and carries out the intake stroke injection by the intake passage injector 100 and the compression stroke injection by the cylinder injector 50), the fuel injection timing of the cylinder injector 50 is adapted to the intake stroke. However, the fuel injection timing of the cylinder injector 50 may be temporarily adapted to the compression stroke to stabilize the combustion by the following reasons.

By adapting the fuel injection timing of the cylinder injector 50 to the compression stroke, in the state that the temperature in the cylinder is relatively higher, the mixed gas is cooled by the fuel injection. Because the cooling effect increases, the performance against knock can be improved. Also, if adapting the fuel injection timing of the cylinder injector 50 to the compression stroke, improvement of an air stream due to the atomizing is achieved by the shortening of a time from the fuel injection to the ignition timing, and a combustion speed increases. The change of the combustion may be avoided by improving of the performance against knock and the increase in the combustion speed, and thus the combustion stability can be improved.

Independently of the temperature of the engine 500 (i.e., any one of a warm state or a cold state), in an off-idle state (an idle switch is in an off state, an accelerator pedal is in a depressed state), the map for a warm state depicted in FIG. 7 or FIG. 9 can be used(regardless of a cold state or a warm state, the cylinder injector 50 is used in the low load region).

While the invention has been shown and described with respect to the example embodiments, it will be understood by those skilled in the art that various changes and modification may be made without departing from the spirit and scope of the invention as defined in the following claims.

1. A control device for an internal combustion engine, comprising:
a detecting unit for detecting knock occurring in the internal combustion engine of a vehicle;
an adjusting unit for adjusting an amount of intake air inducted into the internal combustion engine;
a retarding unit for retarding an ignition timing of the internal combustion engine corresponding to detection of knock;
a learning unit for learning a retard amount used in retarding the ignition timing;
a calculating unit for calculating a limit value of the amount of intake air based on both the learned retard amount and a temperature of intake air inducted into the internal combustion engine; and
a control unit for controlling the adjusting unit by using the calculated limit value when the vehicle is started from an idle state of the internal combustion engine.

2. The control device for an internal combustion engine according to claim 1, further comprising a unit for detecting an a depression amount of an accelerator,
wherein the control unit includes a unit for controlling the adjusting unit by using the calculated limit value of the amount of intake air when the depression amount of the accelerator is larger than a predetermined value.

3. The control device for an internal combustion engine according to claim 1, further comprising a unit for detecting a degree of change of a depression amount of an accelerator which is manipulated by a driver of the vehicle,
wherein the control unit includes a unit for controlling the adjusting unit by using the calculated limit value of the amount of intake air when the degree of change of the depression amount of the accelerator is larger than a predetermined value.

4. The control device for an internal combustion engine according to claim 1, wherein the control unit includes a unit for controlling the adjusting unit by using the calculated limit value of the amount of intake air if the temperature of intake air is higher than a predetermined value when the vehicle is started from the idle state of the internal combustion engine.

5. The control device for an internal combustion engine according to claim 1, wherein the calculating unit includes a unit for calculating a limit value of the intake air amount to which the intake air amount is restricted, and
wherein the limit value decreases with increasing the learned retard amount or increasing the temperature of intake air inducted into the internal combustion engine.

6. A control method for an internal combustion engine, comprising:
determining whether knock is occurring in the internal combustion engine of a vehicle;
adjusting an amount of air intake into the internal combustion engine;
retarding an ignition timing of the internal combustion engine corresponding to detection of knock;
learning a retard amount used to retard the ignition timing;
calculating a limit value of the amount of intake air with both parameters of the learned retard amount and a temperature of intake air inducted into the internal combustion engine; and
controlling the adjusting the amount of air by using the calculated limit value when the vehicle is started from an idle state of the internal combustion engine.

7. The control method for an internal combustion engine according to claim 6, further comprising detecting an depression amount of an accelerator,
wherein the adjusting the amount of intake air is controlled using the calculated limit value of the amount of intake air if the depression amount of the accelerator is larger than a predetermined value.

8. The control method for an internal combustion engine according to claim 6, further comprising detecting a degree of change of an depression amount of an accelerator,
wherein the controlling the adjusting the amount of air includes controlling the adjusting the amount of air by using the calculated limit value of the amount of intake air if the degree of change of the depression amount of the accelerator is larger than a predetermined value.

9. The control method for an internal combustion engine according to claim 6, wherein the controlling the adjusting the amount of air includes controlling the adjusting the amount of air by using the calculated limit value of the amount of intake air if the temperature of intake air is higher than a predetermined threshold value when the vehicle is started from the idle state of the internal combustion engine.

10. The control method for an internal combustion engine according to claim 6, wherein the calculating the limit value of the amount of intake air includes calculating a limit value of the intake air amount to which the intake air amount is restricted, and
wherein the limit value decreases with increasing the learned retard amount or increasing the temperature of intake air inducted into the internal combustion engine.

11. The control device for an internal combustion engine according to claim 1, further comprising a multi-dimensional map related to the speed of the engine and an engine load,
wherein the learning unit derives a compensation value for controlling the ignition timing based on the speed of the engine and the engine load from the map, and learns by using the compensation value.

12. The control device for an internal combustion engine according to claim 11, wherein the learning unit modifies the derived ignition timing control learning value according to conditions that influence a knock limit ignition timing, and initiates the learning by using the modified ignition timing control compensation value.

13. The control method for an internal combustion engine according to claim 6, further comprising preparing a multi-dimensional map related to the speed of the engine and an engine load,
wherein the learning the retard amount includes deriving a compensation value for controlling the ignition timing based on the speed of the engine and the engine load from the map, and learning by using the compensation value.

14. The control method for an internal combustion engine according to claim 13, wherein the learning the retard amount includes modifying the derived ignition timing control learning value according to conditions influencing a knock limit ignition timing, and initiating the learning by using the modified ignition timing control compensation value.

15. The control method for an internal combustion engine according to claim 6, further comprising:
preparing a map in which a control region for fuel injection into a combustion chamber of the internal combustion engine and a control region for fuel injection into an intake passage of the internal combustion engine are set differently; and
controlling selectively the fuel injection into the combustion chamber and the intake passage by using the map, if the temperature of the internal combustion engine is more than a predetermined temperature.

16. The control method for an internal combustion engine according to claim 15, wherein the preparing the map includes providing a map for a warm engine and a map for a cold engine, and
the selective control of the fuel injection includes selecting the map for a warm engine if the temperature of the internal combustion engine is more than the predetermined temperature; selecting the map for a cold engine if the temperature of the internal combustion engine is not more than the predetermined temperature; and injecting the fuel into the combustion chamber and/or the intake passage based on the speed of the engine and the load factor from the map which is respectively selected.

17. The control method for an internal combustion engine according to claim 16, wherein the injecting the fuel includes adapting a fuel injection timing to a intake stroke or a compression stroke of the internal combustion engine if the fuel injection into the combustion chamber is selected.

18. The control method for an internal combustion engine according to claim 16, wherein the selective control of the fuel injection includes using the map for a warm engine independently of the temperature of the internal combustion engine if the internal combustion engine is in an off-idle state.

19. A program for performing a control method for use in an internal combustion engine by a computer, the control method comprising:
detecting knock occurring in the internal combustion engine of a vehicle;
adjusting an amount of intake air inducted into the internal combustion engine;
retarding an ignition timing of the internal combustion engine corresponding to detection of knock;
learning a retard amount used in retarding the ignition timing;
calculating a limit value of the amount of intake air based on both the learned retard amount and a temperature of air intake into the internal combustion engine; and
controlling the adjusting the amount of air by using the calculated limit value when the vehicle is started from an idle state of the internal combustion engine.

20. A computer readable storage medium for storing a program that performs a control method for use in an internal combustion engine, the control method comprising:
detecting knock occurring in the internal combustion engine of a vehicle;
adjusting an amount of intake air inducted into the internal combustion engine;
retarding an ignition timing of the internal combustion engine corresponding to detection of knock;
learning a retard amount used in retarding the ignition timing;
calculating a limit value of the amount of intake air based on both the learned retard amount and a temperature of air intake into the internal combustion engine; and
controlling the adjusting the amount of air by using the calculated limit value when the vehicle is started from an idle state of the internal combustion engine.
